(19) United States
(12) Patent Application Publication
(10) Pub. No.: US 2026/0150963 A1
(43) Pub. Date: Jun. 4, 2026

(54) TELESCOPIC RAIL WITH END POSITION LOCKING AND SELF-CLOSING MECHANISM

(71) Applicant: Accuride International GmbH, Diez (DE)

(72) Inventors: Thomas WAGNER, Hünfelden (DE); Christoph NEHAUS, Niederelbert (DE)

(21) Appl. No.: 19/400,095

(22) Filed: Nov. 25, 2025

(30) Foreign Application Priority Data
Nov. 29, 2024 (DE) 10 2024 135 524.7

(51) Int. Cl. A47B 88/49; A47B 88/467; A47B 88/473

(52) U.S. Cl. CPC A47B 88/49; A47B 88/473; A47B 2088/4675

(57) ABSTRACT

Telescopic rail with an outer rail, a middle rail, and an inner rail, which, even with a compact design, has both a self-closing mechanism and a mechanism for releasable locking of the rail elements in the fully extended end position.

### SUBJECT OF THE INVENTION

The present invention relates to a telescopic rail designed as a full extension rail with an outer rail, at least one middle rail, and an inner rail, which are mounted on each other so that they can be moved linearly in an insertion direction and in an opposite pull-out direction.

### BACKGROUND OF THE INVENTION

Telescopic rails generally have two rail elements and optionally a third, or in some cases a fourth rail element, whereby the rail elements are usually of equal or similar length and are mounted so that they can be moved linearly relative to each other via roller bearings or plain bearings. Telescopic rails with two rail elements form a so-called partial extension, whereas telescopic rails with three or more rail elements are referred to as full extension or over-extension rails. Rolling element or plain bearings between the rail elements serve to reduce friction and improve running smoothness and load transfer. Balls in particular are used as rolling elements, but rollers, needles, cones, etc. are also used. When the rail elements are moved against each other, the rolling elements are rolled and guided on raceways, which are designed on the rail elements to match the shape of the rolling elements. In plain bearings, either sliding elements are guided between the rail elements on appropriately designed raceways or sliding surfaces are formed on the rail elements themselves.

In order to keep rolling elements at a certain distance from each other and to prevent them from running apart or falling out of the telescopic rail when the rail elements are moved, they are guided in rolling element cages arranged between the rail elements. If balls are used as rolling elements, these are referred to as ball cages. Wherever balls are referred to as rolling elements and ball cages as rolling element cages in the following, this also includes other types of rolling elements and rolling element cages, unless expressly excluded or unless technical reasons exclude rolling elements other than balls.

Telescopic rails are used for the guided linear movement of one element relative to another. In most applications, they are used to hold and linearly move, in particular to pull out and push in, a pull-out element, such as a drawer, a shelf, or another component, on a body, such as a piece of furniture, a technical cabinet, a computer rack, or similar. Telescopic rails are also used in automotive engineering to hold and move seats, doors, consoles, etc., or for drawers in the vehicle interior. In these applications, the telescopic rails are fixed to the body with one of the rail elements, the so-called stationary rail element, and the element to be moved is attached to a rail element that can be moved relative to the stationary rail element.

The rail elements of telescopic rails can have a wide variety of cross-sectional profiles. The most common is the C-profile with a web forming the back of the rail and flanges formed at opposite ends of the web and extending at an angle from the web, on which the raceways of the rail element are formed. In addition to the C-profile, the double-T-profile is also used as a middle rail between two other rail elements. In a middle rail designed as a C-profile, two running tracks are regularly formed on each of the two flanges of the C-profile, one on the inside of the flange facing the opposite flange of the C-profile and one on the outside of the flange facing away from the opposite flange of the C-profile. The flanges of the middle rail grip around a rail element that is usually smaller with a shorter web length, also known as the inner rail, while the middle rail itself is gripped by a rail element that is usually larger with a longer web length, also known as the outer rail.

In most applications, the rail elements are mounted with the web or rail back in a vertical orientation, as the profile has the highest bending strength in this orientation under load and ensures the best load transfer via the rolling or sliding elements on the raceways.

It is well known to equip telescopic rails with a so-called self-closing mechanism for power-assisted retraction of the rail elements over a final distance into the fully retracted position. Telescopic rails with self-closing mechanism are often used in drawers, for example. As a rule, the self-closing mechanism is fixed to the stationary rail element at its end section in the insertion direction and has a driver that is preloaded or can be preloaded in the insertion direction by a spring or retraction element. When the telescopic rail is pulled out, the driver is carried along in the pull-out direction by a movable rail element with which it is engaged via a retaining trap, against the preload of the spring or retraction element, locked in the insertion direction at a distance from the fully retracted position under preload, and is disengaged from the retaining trap of the rail element moving in the pull-out direction so that the same can be moved further in the pull-out direction. When the movable rail element is pushed in, it hits the driver, engages with it via the retainer, releases the driver from the lock, and is pulled in over the last distance to the fully inserted position.

It is also known to detachably lock the displaceable rail elements of a telescopic rail against each other in the end position in the extended state in order to hold a rail element in the fully extended end position so that it cannot be pushed back in unintentionally, but only by applying a force specified by the respective locking mechanism.

In many installation situations, it is necessary for the telescopic rails to be compact in design so that it takes up as little space as possible, especially in the lateral extension perpendicular to its longitudinal extension between the body and the pull-out element to be moved. To achieve this, the rail elements of the telescopic rail, for example those with a C-profile, are therefore arranged with as little distance as possible between their rail backs. As a result, however, the available installation space between the rail elements for accommodating additional components is also limited.

For certain applications, it would be desirable to equip a telescopic rail designed as a full extension with both a self-closing mechanism for power-assisted retraction of the rail elements over a final distance to the fully retracted position and a mechanism for detachable locking of the rail elements in the fully extended end position. However, the combination of these two functions cannot be achieved with the known designs of self-closing mechanisms and locking mechanisms, particularly in telescopic rails with a compact design, because they block each other in the limited space available between the rail elements. At least one of the two functions would have to be located outside the installation space between the rail elements or completely outside the telescopic rail, which would be costly and take up additional space outside the rail elements or the telescopic rail.

An object of the present invention was therefore to provide a telescopic rail designed as a full extension rail, which eliminates the aforementioned disadvantages of the prior art and, even with a compact design, features both a self-closing mechanism and a mechanism for detachable locking of the rail elements in the fully extended end position.

### DESCRIPTION OF THE INVENTION

According to the invention, this object is solved by a telescopic rail designed as a full extension according to the attached independent claim 1, which has a self-closing mechanism for power-assisted retraction of the rail elements over a final distance into the fully retracted position and, at the same time, a mechanism for detachable locking of the rail elements in the fully extended end position. Embodiments and further configurations are set out in the dependent subclaims.

The telescopic rail according to the invention makes it possible, even in telescopic rails with a compact design and narrow installation space between the rail elements, to realize the advantages of a self-closing mechanism in combination with an end position locking mechanism in the fully extended end position and to arrange the elements required for this between the rail elements.

The telescopic rail according to the invention is designed as a full extension rail with an outer rail, a middle rail, and an inner rail. The inner rail is mounted so that it can be moved linearly between a first insertion end position and a first pull-out end position on the middle rail in an insertion direction (E) and an opposite pull-out direction (A), and the middle rail is mounted so that it can be moved linearly between a second insertion end position and a second pull-out end position on the outer rail in the insertion direction (E) and the opposite pull-out direction (A).

The first insertion end position and the first pull-out end position describe the positions at which the inner rail is fully inserted relative to the middle rail in the insertion direction or fully extended relative to the middle rail in the pull-out direction. The second insertion end position and the second pull-out end position describe the positions in which the middle rail is fully inserted relative to the outer rail in the insertion direction and fully extended relative to the middle rail in the pull-out direction. The insertion end position of the entire telescopic rail describes the position in which all rail elements are fully inserted, i.e., the inner rail is in the first insertion end position relative to the middle rail and the middle rail is in the second insertion end position relative to the outer rail. This is equivalent to the insertion end position of the inner rail relative to the outer rail.

Preferably, the rail elements are mounted on each other in a movable manner via roller bearings or plain bearings. It is particularly preferred that the rail elements are mounted on each other in a movable manner via ball bearings with balls arranged and guided in ball cages.

In general, such telescopic rails are equipped with stops in both directions of movement, which limit the movement of the individual rail elements relative to each other so that the rail elements cannot run apart and become separated from each other. An end position refers to the end of a movement in the corresponding direction of movement due to the limitation by such a stop. The outer rail, the middle rail, and the inner rail each have a rail back and sections extending at an angle from the rail back with raceways formed thereon. In embodiments of the telescopic rail according to the invention, in which the rail elements are mounted on each other in a displaceable manner via rolling element bearings or plain bearings, the raceways are provided and designed for the rolling of rolling elements or for the guidance of sliding elements.

In embodiments of the invention, the outer rail, the middle rail, and the inner rail have a C-profile in cross-section with a rail back formed by the web of the C-profile and with raceways formed on the flanges of the C-profile for rolling of rolling elements or for guiding sliding elements.

In alternative embodiments of the invention, the outer rail and the inner rail have a C-shaped cross-section, and the middle rail has a double-T-shaped cross-section profile with a rail back formed by the web of the double-T profile and with raceways formed on the flanges of the double-T profile for rolling of rolling elements or for guiding sliding elements.

According to the invention, detachable locking of the rail elements is to be achieved when the telescopic rail is fully extended, i.e., when the middle rail and the inner rail are in their fully extended end positions. For this purpose, according to the invention, when the telescopic rail is fully extended, both the inner rail is locked relative to the middle rail in the first pull-out end position and the middle rail is locked relative to the outer rail in the second pull-out end position. In this context, locking means that in order to release the lock from the fully extended end position, a force (release force) in the insertion direction that is greater than the force required to move the rail elements out of the locking position, or that a release mechanism, for example a release lever, must be actuated to release the locking mechanism from the fully extended end position.

According to the invention, the middle rail therefore has a first locking element and the inner rail has a second locking element, wherein the first locking element and the second locking element are designed for form-fitting and/or force-fitting detachable engagement and for locking the middle rail and the inner rail. The locking elements are arranged and designed in such a way that the middle rail and the inner rail are locked when the rail elements are in a position in which the inner rail has been moved in the pull-out direction (A) to the first pull-out end position on the middle rail. In embodiments of the invention, the first locking element is fixed to the middle rail or formed integrally therewith and/or the second locking element is fixed to the inner rail or formed integrally therewith.

A locking element may, for example, have a locking lug (locking nose) which is guided over a detent for locking or when releasing the lock and which, in the locked position, comes to rest behind the detent in the pull-out direction. Preferably, the locking lug and/or the lock is an elastic or spring-biased element and/or provided with guide ramps to ensure or facilitate the locking lug passing over the lock or vice versa into or out of the locked position. At least one of the elements, the locking lug or the detent, gives way to the other element when passing over it or is elastically deformable for passing over.

In alternative embodiments, the locking lug is designed for engagement with the lock in the engagement position in such a way that it can be moved into the engagement position by gravity. The lock is released either by moving over a lead-in slope (guide ramp) or by means of a lever or an actuating tab to be operated by an operator.

In further embodiments, in which the rail elements are mounted so that they can be displaced relative to one another via ball bearings, a ball detent is provided for detachable locking of the inner rail relative to the middle rail in the fully extended end position, i.e., in the first pull-out end position. For this purpose, a protruding embossing or elevation is provided on the raceway of the middle rail at an end section arranged in the pull-out direction as a first locking element, which is passed over by at least the ball of the ball bearing arranged outermost in the pull-out direction when the inner rail is moved in the pull-out direction just before reaching the first pull-out end position, thereby causing a locking action. To release the locking action from the first pull-out end position, an increased force must be applied to guide the ball back over the protruding embossing or elevation in the insertion direction. The ball of the ball bearing is thus to be understood as the second locking element in the sense of the present invention.

Furthermore, according to the invention, a retaining trap is arranged on the middle rail for releasable locking of the middle rail relative to the outer rail, which retaining trap is mounted so that it can rotate or pivot between a retaining position and a neutral position about an rotation axis arranged perpendicular to the insertion direction (E) and the opposite pull-out direction (A).

In embodiments of the telescopic rail according to the invention, the retaining trap is mounted in an end section of the middle rail facing the insertion direction. In further embodiments of the telescopic rail according to the invention, the retaining trap is mounted in a section of the middle rail which is located between the end section of the middle rail pointing in the insertion direction and the end section of the inner rail pointing in the insertion direction when the inner rail is moved in the pull-out direction to the first pull-out end position, i.e., fully extended, on the middle rail.

A rotation axis is provided for the rotatable or swiveling attachment of the retaining trap, preferably a pivot bearing. The pivot bearing can be realized, for example, by a bearing pin, which extends through a bore in the retaining trap. Alternative designs of suitable pivot bearings are generally known to those skilled in the art.

A retaining projection is arranged on the back of the outer rail, which protrudes from the back of the outer rail on the side of the rail back facing the middle rail or rises from the back of the outer rail and is arranged at a position such that the retaining trap is arranged behind the retaining projection in the pull-out direction (A) when the middle rail has been moved in the pull-out direction (A) to the second pull-out end position on the outer rail. In embodiments, the retaining projection is an element welded or screwed to the rail back of the outer rail. In further embodiments, the retaining projection is formed from the material of the rail back by embossing the material or by a tab cut out of the material of the rail back and bent over.

The retaining trap has a first retaining trap section extending perpendicular to the rotation axis of the retaining trap and a second retaining trap section extending at an angle from the first retaining trap section in a direction toward the back of the outer rail.

The second retaining section of the retaining trap is designed and arranged such that, in the retaining position of the retaining trap, it engages with the retaining projection protruding from the back of the outer rail in order to block the middle rail from moving out of the second end position in the insertion direction. This locks the middle rail relative to the outer rail in the second pull-out end position. In the neutral position of the retaining trap, the second retaining trap section of the retaining trap is in a position such that, when the middle rail is moved from the second pull-out end position in the insertion direction, it does not engage with the retaining projection protruding from the back of the outer rail, but can pass past it. In the neutral position of the retaining trap, the middle rail is released for movement from the second pull-out end position in the insertion direction.

The retaining projection is designed so that it protrudes from the back of the outer rail only to a distance such that the first retaining trap section of the retaining trap does not come into contact with the retaining projection when the middle rail is moved relative to the outer rail, but can be guided over it in the insertion direction or pull-out direction when the retaining trap is in the neutral position.

Furthermore, according to the invention, a self-closing mechanism is fixed to the end section of the outer rail pointing in the insertion direction for power-assisted displacement of the inner rail from a position at a distance from the insertion end position of the inner rail relative to the outer rail into the insertion end position, in which the telescopic rail is fully inserted. The self-closing mechanism has a driver and a power assist element connected to the driver, such as a tension spring or a compression spring. The driver can be locked by the power assist element in the insertion direction at a distance from the insertion end position.

According to the invention, the middle rail is pulled into the second insertion end position by retracting the inner rail by the self-closing mechanism into the insertion end position of the inner rail relative to the outer rail, thereby also retracting the middle rail, since the inner rail cannot be moved beyond the first insertion end position relative to the middle rail when moving in the insertion direction. For this purpose, a retainer for detachable engagement with the driver on the self-closing mechanism is arranged at the end section of the inner rail pointing in the insertion direction. The retainer is designed so that it engages and remains engaged with the driver when the driver is pulled by the power assist element in the insertion direction into the insertion end position of the inner rail opposite the outer rail.

If the inner rail is pulled out of the insertion end position relative to the outer rail in the pull-out direction, the driver is pulled by the power assist element against the preload directed in the insertion direction.

Preferably, the retainer is formed on the end section of the inner rail facing in the insertion direction so that, when the inner rail is moved in the pull-out direction, it moves the driver into a locking position at a distance from the insertion end position of the inner rail relative to the outer rail, for example by moving the driver sideways into a retaining position, for example at a detent. At the same time, the retainer disengages from the driver so that the inner rail can continue to be moved in the pull-out direction. In the reverse direction of movement, i.e., when the inner rail is moved in the insertion direction, the retainer is designed to engage with the driver and release the driver from the locking position so that the inner rail is pulled back into the insertion end position with the aid of power assistance. This can be achieved in such a way that the retainer first receives the driver through an insertion opening and, as it continues to move in the insertion direction, displaces it transversely or laterally at correspondingly arranged surfaces, whereby the driver is released from the locking and at the same time is engaged with the retaining trap, e.g., at an undercut, to prevent unintentional release.

According to the invention, the retainer is arranged and designed on the end section of the inner rail pointing in the insertion direction in such a way that, when the inner rail is moved relative to the middle rail in the insertion direction into the first insertion end position, it does not come into contact with the retaining trap on the middle rail and does not come into contact with the retaining projection protruding from the rail back of the outer rail, but can be moved spatially over the retaining trap and the retaining projection or sideways past them in the insertion direction.

According to preferred embodiments of the telescopic rail according to the invention, the outer rail, the middle rail, and the inner rail are made of rolled steel sheet. This allows for cost-effective production of stable and resilient rail elements.

In embodiments of the invention, the retaining trap on the middle rail has a C-profile or an L-profile in cross-section at its end section facing in the insertion direction (E), wherein the first retaining trap section extending perpendicular to the rotation axis is formed by the web of the C-profile or by a leg of the L-profile, and the second retaining trap section, which extends at an angle from the first retaining trap section in a direction towards the rail back of the outer rail, is formed by a flange of the C-profile or by the other leg of the L-profile.

Preferably, the first retaining trap section formed by the web of the C-profile or by one leg of the L-profile is rotatable or pivotable parallel to the plane of the rail back of the outer rail. The rotation axis is thus preferably arranged perpendicular to the plane of the rail back of the outer rail.

In embodiments of the invention, the first retaining trap section extends to the rotation axis at which the retaining trap is pivotable or swivelable on the middle rail between a retaining position and a neutral position. The rotation axis is preferably perpendicular to the plane of the first retaining trap section.

In embodiments of the invention, the retaining trap on the middle rail, when it is in the neutral position or relative to the neutral position, has a width perpendicular to the insertion direction (E) and to the pull-out direction (A) that is less than the shortest distance between the raceways of the inner rail. This means that the retaining trap at the end section of the middle rail can be inserted between the raceways of the inner rail when the inner rail is pushed over the retaining trap in the insertion direction (E).

In embodiments of the invention, when the telescopic rail is aligned horizontally with respect to the insertion direction (E) and the pull-out direction (A) and the rail backs of the rail elements are aligned vertically, the retaining trap on the middle rail can be rotated or pivoted by gravity from the neutral position to the retaining position. This embodiment does not require any additional means for rotating or pivoting the retaining trap between the neutral position and the retaining position and is therefore generally suitable and advantageous when the telescopic rail is intended for installation with vertical (perpendicular) orientation of the rail backs, such as for guiding drawers or other pull-outs on a vertically (perpendicularly) oriented cabinet wall. In advantageous embodiments of this design, the retaining trap has a C-profile at its end in the insertion direction, so that in and against the direction of gravity, a second retaining trap section extending at an angle from the first retaining trap section is provided, which can engage with the retaining projection on the outer rail in the retaining position for locking. This design allows the same telescopic rails to be used on opposite sides of a pull-out. When telescopic rails are installed opposite each other, the second retaining trap section, which is arranged vertically at the top of one telescopic rail, i.e., against the direction of gravity, is arranged vertically at the bottom of the opposite telescopic rail, i.e., in the direction of gravity, and therefore cannot engage with the retaining projection on the outer rail for locking in the retaining position. However, in the C-profile of the retaining trap, a second retaining trap section is always arranged vertically at the top, i.e., against the direction of gravity, when the telescopic rails are installed opposite each other.

In alternative embodiments of the invention, a spring element or pull element is provided on the middle rail, which biases the retaining trap on the middle rail for rotation or pivoting from the neutral position to the retaining position or pulls it from the neutral position to the retaining position. This embodiment allows, for example, the telescopic rail to be installed horizontally or at an angle, i.e., with the rail backs of the rail elements aligned horizontally or at an angle, or in a position in which the retaining trap cannot be rotated or pivoted between the neutral position and the retaining position by gravity.

In embodiments of the invention, the retaining trap on the middle rail has at least one ramp or lead-in slope at the first retaining trap section, which is arranged to engage with an end section of the inner rail, preferably an end section of a raceway of the inner rail, when the retaining trap is in the retaining position rotated or pivoted about the rotation axis. The ramp is designed and arranged for turning or pivoting the retaining trap from the retaining position into the neutral position when the inner rail is moved in the insertion direction (E).

When the inner rail hits the ramp of the retaining trap in the retaining position, it pushes the retaining trap out of the retaining position and into the neutral position as it continues to move in the insertion direction, so that the middle rail is released from its engagement with the outer rail in the second pull-out end position and can be moved in the insertion direction into the second insertion end position.

In embodiments of the invention, the power assist element connected to the driver on the self-closing mechanism comprises at least one spring element selected from pull spring elements, push spring elements, and combinations thereof. In preferred embodiments, the power assist element on the self-closing mechanism comprises at least one coil spring.

In embodiments of the invention, the self-closing mechanism further comprises a damping element, preferably at least one air pressure damper or oil pressure damper, which is arranged to dampen the displacement and/or the power-assisted displacement or retraction of the inner rail into the second insertion end position.

In embodiments of the invention, the driver on the self-closing mechanism is designed as a pin or a tab, which protrudes in a direction perpendicular to the rail back of the outer rail, and the retainer at the end section of the inner rail has an inlet opening for inserting the driver and guide surfaces for guiding the driver sideways.

Further advantages, features, and possible applications of the present invention will become apparent from the following description of embodiments thereof and the accompanying figures. In the figures, identical elements are designated by identical reference numerals.

### FIGURES

FIG. 1 shows an embodiment of a telescopic rail according to the invention with an outer rail, a middle rail, and an inner rail with the rail elements fully inserted into an end position in a side view looking at the outside of the inner rail;

FIG. 2 shows the telescopic rail according to the invention as per the embodiment in FIG. 1 with the rail elements fully extended, wherein the inner rail is locked relative to the middle rail in the first pull-out end position and the middle rail is locked relative to the outer rail in the second pull-out end position, in a side view looking at the outside of the inner rail;

FIGS. 2b and 2c show sectional views along line X-X in FIG. 2a in a broken view obliquely from the front (FIG. 2b) and in a view from the front (FIG. 2c);

FIG. 3a shows the telescopic rail according to the invention as per the embodiment in FIG. 1 with the middle rail in the fully extended second pull-out end position and with the inner rail moved in the insertion direction relative to the first pull-out end position, in a side view looking at the outside of the inner rail;

FIGS. 3b and 3c show sectional views along line X-X in FIG. 3a in a broken view obliquely from the front (FIG. 2b) and in a view from the front (FIG. 3c);

FIG. 4 shows schematically a broken view through a longitudinal section through the telescopic rail according to the embodiment in FIG. 1 with fully extended rail elements, showing the first and second locking elements on the middle rail and the inner rail.

### DETAILED DESCRIPTION OF THE INVENTION

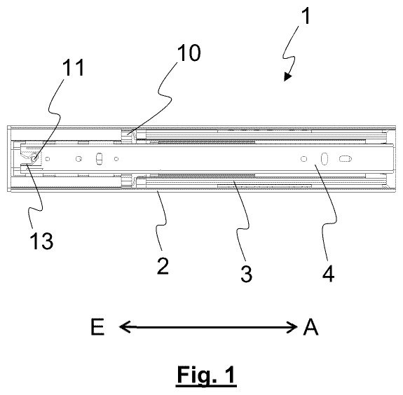

FIGS. 1 to 4 show different views and insertion situations of an embodiment of a telescopic rail 1 according to the invention with an outer rail 2, a middle rail 3, and an inner rail 4. The inner rail 4 is mounted so that it can be displaced linearly relative to the middle rail 3 and the middle rail 3 is mounted so that it can be displaced linearly relative to the outer rail 2 between respective insertion end positions and pull-out end positions in an insertion direction E and an opposite pull-out direction A. The insertion direction E and the opposite pull-out direction A are indicated in FIG. 1 by a double arrow pointing in the respective directions. The rail elements 2, 3, 4 are mounted on each other in a displaceable manner via ball bearings with balls arranged and guided in ball cages. The telescopic rail is equipped with stops in both displacement directions, which limit the displacement of the individual rail elements relative to each other so that the rail elements cannot be displaced beyond their respective end positions and thus cannot run apart and become separated from each other.

In the embodiment of the invention shown, the outer rail 2, the middle rail 3, and the inner rail 4 each have a C-shaped cross-section with a rail back formed by the web of the C-shaped profile and with raceways formed on the flanges of the respective C-shaped profile for rolling the balls of the ball bearings.

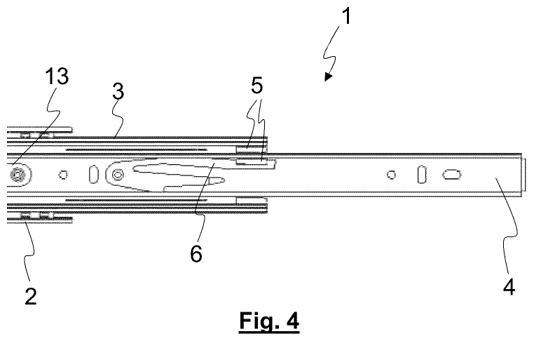

The middle rail has a first locking element 5 and the inner rail has a second locking element 6, shown in the sectional view in FIG. 4, for form-fitting and force-fitting detachable engagement and for locking the inner rail and the middle rail when the inner rail is moved in the pull-out direction A to the first pull-out end position on the middle rail. In the present embodiment, the first and second locking elements 5 and 6 are designed as plastic molded parts and are fixed to the respective rail elements. The second locking element 6 fixed to the inner rail 4 has a spring-biased arm extending in the pull-out direction with a recess. The first locking element 5 on the middle rail 3 has an elongated locking nose which, when the inner rail 4 is moved, is brought into contact with the spring-loaded arm of the first locking element 5, pushes it away parallel to the back of the inner rail against the spring preload, and comes to rest in the recess on the second locking element 6 for locking. Lead-in slopes are provided to ensure or facilitate the pushing away of the spring-biased arm of the locking nose when moving into the locking position and when moving out of the locking position.

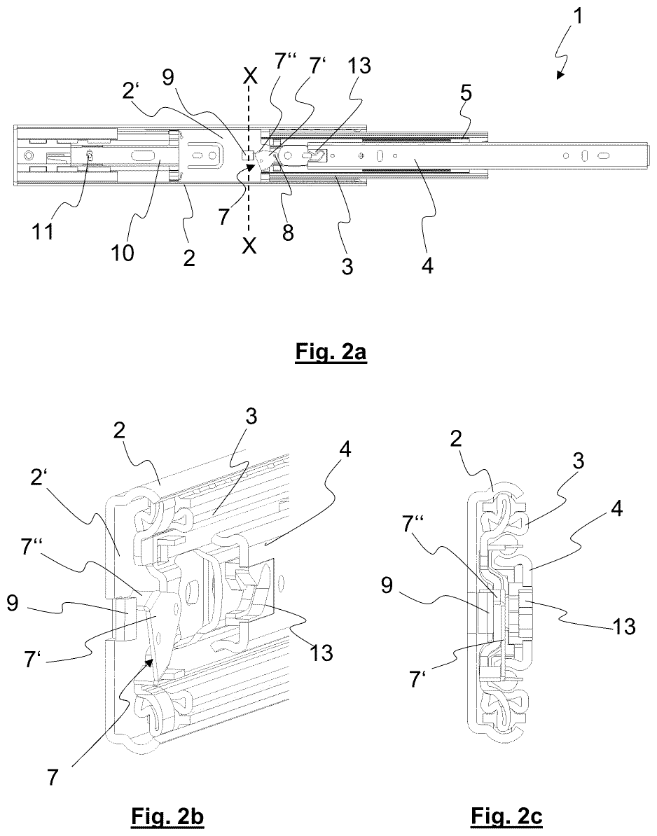

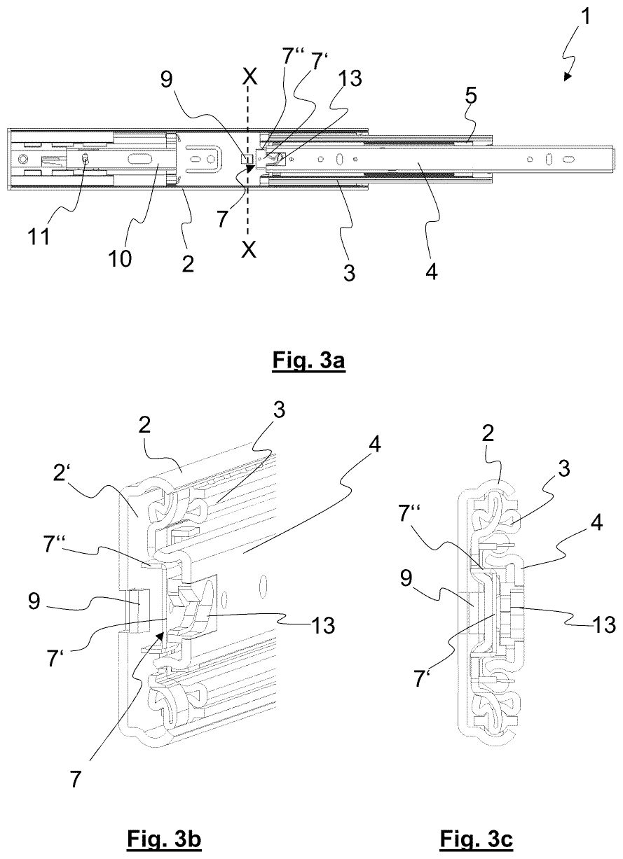

For detachable locking of the middle rail 3 relative to the outer rail 2, a retaining trap 7 is arranged on the middle rail 3, which is fixed rotatably between a retaining position and a neutral position about a pivot axis 8, which pivot axis is arranged perpendicular to the insertion direction E and the opposite pull-out direction A and herein extends perpendicular to the plane of the rail back 2′ of the outer rail 2. FIGS. 2a-2c show the retaining trap 7 in the retaining position, while FIGS. 3a-3c show the retaining trap 7 in the neutral position.

A retaining projection 9 is arranged on the rail back 2′ of the outer rail 2, which projects from the rail back 2′ of the outer rail 2. In the present embodiment, the retaining projection 9 is designed as a tab cut out of the material of the rail back and bent up in a cranked manner.

The retaining projection 9 is arranged on the rail back 2′ of the outer rail 2 at a position such that the retaining trap 7 is arranged behind the retaining projection 9 when the middle rail 3 is moved in the pull-out direction A to the second pull-out end position on the outer rail 2.

The retaining trap 7 has a first retaining trap section 7′ extending perpendicular to the rotation axis 8 of the retaining trap 7 and parallel to the rail back of the outer rail, and a second retaining trap section 7″ extending at an angle from the first retaining trap section 7′ in a direction toward the rail back 2′ of the outer rail 2. The second retaining trap section 7″ of the retaining trap 7 is designed and arranged such that, in the retaining position of the retaining trap 7, it engages with the retaining projection 9 protruding from the rail back 2′ of the outer rail 2 in order to block the middle rail 3 from moving out of the second pull-out end position in the insertion direction, as shown in FIG. 2. This locks the middle rail relative to the outer rail in the second pull-out end position. In the neutral position of the retaining trap 7 shown in FIG. 3, the second retaining trap section 7″ of the retaining trap 7 is in a position such that, when the middle rail 3 is moved from the second pull-out end position in the insertion direction, it does not engage with the retaining projection 9 protruding from the rail back 2′ of the outer rail 2, but can pass past it. In the neutral position of the retaining trap 7, the middle rail is released for movement from the second pull-out end position in the insertion direction.

The retaining projection 9 is designed so that it protrudes from the rail back 2′ of the outer rail 2 only to a distance such that the first retaining trap section 7′ of the retaining trap 7 does not come into contact with the retaining projection 9 when the middle rail 3 is moved relative to the outer rail 2, but can be guided over it in the insertion direction or pull-out direction when the retaining trap is in the neutral position.

In the present embodiment, the retaining trap 7 can be rotated by gravity from the neutral position to the retaining position when the telescopic rail is arranged horizontally with respect to the insertion direction E and the pull-out direction A and with the rail backs of the rail elements aligned vertically, which is the regular arrangement in many applications, such as for guiding drawers on a cabinet. In the present embodiment, the retaining trap 7 has a C-profile at its end in the insertion direction, so that the second retaining trap section 7″ located at the top in the direction of gravity in the present illustrations is opposed by a corresponding retaining trap section at the bottom in the direction of gravity. This design allows the same telescopic rails to be used in reverse orientation on opposite sides of a drawer or in opposite sliding directions, since the C-profile of the retaining trap 7 always means that a second retaining trap section is located at the top in relation to the direction of gravity and can fall into the locking position under the force of gravity.

In the present embodiment, the retaining trap 7 in the neutral position or, relative to the neutral position, perpendicular to the insertion direction E and the withdrawal direction A has a width that is less than the shortest distance between the raceways of the inner rail 4. This means that the retaining trap 7 can be inserted into the middle rail 3 between the tracks of the inner rail 4 when the inner rail 4 is pushed over the retaining trap 7 in the insertion direction E. In addition, the retaining trap 7 has lead-in slopes 7′ which are arranged to engage with an end section of a raceway of the inner rail 4, so that when the inner rail 4 is moved in the insertion direction E, it pushes the retaining trap out of the retaining position into the neutral position and releases the middle rail from the interlocking engagement with the outer rail in the second pull-out end position, allowing it to be moved in the insertion direction.

Furthermore, a self-closing mechanism 10 is fixed to the end section of the outer rail 2 pointing in the insertion direction for power-assisted displacement or retraction of the inner rail 4 from a distance from an insertion end position of the inner rail 4 relative to the outer rail 2 into the insertion end position. The self-closing mechanism 10 has a pin-shaped driver 11 extending perpendicular to the rail back 2′ of the outer rail 2 and a power assist element (not shown) connected to the driver 11, which pulls the driver 11 in the insertion direction or which holds the driver 11 preloaded in the insertion direction when the driver 11 is locked at a distance from the insertion end position.

On the end section of the inner rail 4 pointing in the insertion direction there is arranged a retainer 13 for releasable engagement with the driver 11 on the self-closing mechanism 10. The retainer 13 is designed so that it engages and remains engaged with the driver when the driver is pulled by the power assist element in the insertion direction E into the insertion end position of the inner rail 4 relative to the outer rail 2, as shown in FIG. 1. The retainer 13 has an insertion opening in the insertion direction for receiving the driver 11, as well as a contour through which the driver 11 is displaced sideways and, depending on the direction of displacement of the inner rail 4, is brought into or out of engagement with the retainer 13.

If the inner rail 4 is pulled out of the insertion end position relative to the outer rail 2 in the pull-out direction, the driver 11 is pulled by the power assist element from the inner rail 4 against the preload directed in the insertion direction E and is brought into a locked position by a sideways movement at a distance from the insertion end position against the preload by the power assist element. The sideways movement brings the driver 11 into a position where it is disengaged from the retainer 13 through the insertion opening, so that the inner rail can be moved further in the pull-out direction. In the opposite direction, when the inner rail 4 with the retainer 13 is pushed towards the driver 11 in the insertion direction, the driver enters the insertion opening of the retaining bracket 13, is moved sideways along the contour of the retaining bracket as the inner rail 4 continues to move in the insertion direction, engages with the retaining bracket 13 and is released it from the lock at a distance from the insertion end position, so that the inner rail 4 is pulled into the insertion end position with the aid of force.

If the inner rail 4 is moved in the pull-out direction A, it takes the middle rail 3 with it to the second pull-out end position. The retaining trap 7 is in the neutral position and is moved over the retaining projection 9. As soon as the middle rail has reached the second pull-out end position and the inner rail is moved further in the pull-out direction, the inner rail releases the retaining trap 7 so that it is turned by gravity from the neutral position into the retaining position behind the retaining projection 9 and the middle rail 3 locks into place relative to the outer rail 2.

For the purposes of the original disclosure, it should be noted that all features as they appear to a person skilled in the art from the present description, the drawings, and the claims, even if they have been described specifically only in connection with certain other features, can be combined both individually and in any combination with other features or groups of features disclosed herein, unless this has been expressly excluded or technical circumstances make such combinations impossible or meaningless. For the sake of brevity and readability of the description, a comprehensive, explicit presentation of all conceivable combinations of features is omitted here.

While the invention has been presented and described in detail in the drawings and the preceding description, this presentation and description is merely exemplary and is not intended to limit the scope of protection as defined by the claims. The invention is not limited to the disclosed embodiments.

Modifications of the disclosed embodiments will be apparent to those skilled in the art from the drawings, the description, and the accompanying claims. In the claims, the word “comprising” does not exclude other elements or steps, and the indefinite article “a” or “an” does not exclude a plurality. The mere fact that certain features are claimed in different claims does not exclude their combination. Reference signs in the claims are not intended to limit the scope of protection.

### LIST OF REFERENCE SIGNS

1 Telescopic rail
2 Outer rail
2′ Rail back of the outer rail
3 Middle rail
4 Inner rail
5 First locking element (on the middle rail)
6 Second locking element (on the inner rail)
7 Retaining trap (on the middle rail)
7′ First retaining trap section
7″ Second retaining trap section
7′″ Lead-in slope at the first retaining trap section 7′
8 Rotation axis (of the retaining trap)
9 Retaining projection (on the outer rail)
10 Self-closing mechanism
11 Driver (on the self-closing mechanism)
12 Power assist element (on self-closing mechanism)
13 Retainer (on the inner rail)
E Insertion direction
A Pull-out direction

1. A telescopic rail comprising:
an outer rail, a middle rail, and an inner rail,
wherein the inner rail is mounted so as to be linearly displaceable in an insertion direction and a pull-out direction opposite thereto between a first insertion end position and a first pull-out end position on the middle rail,
wherein the middle rail is mounted on the outer rail so as to be linearly displaceable in the insertion direction and the pull-out direction opposite thereto between a second insertion end position and a second pull-out end position,
wherein the outer rail, the middle rail and the inner rail each have a rail back and sections extending at an angle from the rail back with raceways formed thereon,
wherein the middle rail has a first locking element and the inner rail has a second locking element, wherein the first locking element and the second locking element are designed for positive and/or friction-locking detachable engagement and for locking the middle rail and the inner rail in a position in which the inner rail is displaced in the pull-out direction up to the first pull-out end position on the middle rail,
wherein a retaining trap is arranged on the middle rail, which is fixed so that it can rotate or pivot about a rotation axis arranged perpendicular to the insertion direction and the pull-out direction between a retaining position and a neutral position,
wherein a retaining projection is arranged on the rail back of the outer rail and protrudes from the rail back of the outer rail,
wherein the retaining projection is arranged on the rail back of the outer rail at a position such that the retaining trap is arranged behind the retaining projection when the middle rail is moved in the pull-out direction to the second pull-out end position on the outer rail,
wherein the retaining trap has in cross-section a first retaining trap section extending perpendicular to the rotation axis of the retaining trap and a second retaining trap section extending at an angle from the first retaining trap section in a direction towards the rail back of the outer rail,
wherein the second retaining trap section of the retaining trap is designed and arranged such that, in the retaining position of the retaining trap it engages with the retaining projection protruding from the rail back of the outer rail to block the middle rail from moving out of the second pull-out end position in the insertion direction, and that in the neutral position of the retaining trap when the middle rail is moved from the second pull-out end position in the insertion direction it does not engage with the retaining projection protruding from the rail back of the outer rail,
wherein the retaining projection protrudes up to a distance from the rail back of the outer rail and/or the first retaining trap section of the retaining trap is designed and arranged such that the first retaining trap section of the retaining trap does not come into contact with the retaining projection when the middle rail is moved relative to the outer rail,
whereby a self-closing mechanism is fixed to the end section of the outer rail pointing in the insertion direction for force-assisted displacement of the inner rail from a distance from a insertion end position of the inner rail relative to the outer rail into the insertion end position, wherein the self-closing mechanism has a driver and a power assist element connected to the driver, and wherein the driver can be arrested by the power assist element at a distance from the insertion end position in a manner pretensioned in the insertion direction,
wherein a retainer for releasable engagement with the driver on the self-closing mechanism is arranged on the end section of the inner rail pointing in the insertion direction, and
wherein the retainer is arranged and designed such that it does not come into contact with the retaining trap on the middle rail when the inner rail is moved in the insertion direction.

2. The telescopic rail according to claim 1, wherein the outer rail, the middle rail, and the inner rail have a C-profile in cross-section with a rail back formed by the web of the C-profile and with raceways formed on the flanges of the C-profile for the rolling of rolling elements or for the guidance of sliding elements.

3. The telescopic rail according to claim 1, wherein the outer rail, the middle rail, and the inner rail are made of rolled steel sheet.

4. The telescopic rail according to claim 1, wherein the retaining trap on the middle rail has a C-profile or an L-profile in cross-section at its end section facing in the insertion direction, wherein the first retaining trap section extending perpendicular to the rotation axis is formed by the web of the C-profile or by a leg of the L-profile, and the second retaining trap section extending at an angle from the first retaining trap section in a direction toward the rail back of the outer rail is formed by a flange of the C-profile or by the other leg of the L-profile.

5. The telescopic rail according to claim 1, wherein the retaining trap on the middle rail in the neutral position perpendicular to the insertion direction and the pull-out direction has a width that is less than the shortest distance between the tracks of the inner rail.

6. The telescopic rail according to claim 1, wherein the retaining trap on the middle rail can be rotated or pivoted by gravity from the neutral position into the retaining position when the telescopic rail is aligned horizontally with respect to the insertion direction and the extraction direction and the rail backs of the rail elements are aligned vertically, or
wherein a spring element or pull element is provided on the middle rail, which biases the retaining trap on the middle rail for rotation or pivoting from the neutral position into the retaining position.

7. The telescopic rail according to claim 1, wherein the retaining trap on the middle rail has at least one lead-in slope on the first retaining trap section, which is arranged for contact with an end section of the inner rail, when the retaining trap is in the retaining position rotated or pivoted about the rotation axis, and wherein the lead-in slope is designed and arranged for rotating or pivoting the retaining trap from the retaining position into the neutral position when the inner rail is displaced in the insertion direction.

8. The telescopic rail according to claim 1, wherein the power assist element on the self-closing mechanism comprises at least one spring element selected from pull spring elements, push spring elements, and combinations thereof.

9. The telescopic rail according to claim 1, wherein the self-closing mechanism further comprises a damping element, which is arranged to dampen the displacement and/or the power-assisted displacement of the inner rail into the second insertion end position.

10. The telescopic rail according to claim 1, wherein the driver on the self-closing mechanism is designed as a pin or a tab, which protrudes in a direction perpendicular to the rail back of the outer rail, and the retainer at the end section of the inner rail has an entry opening for inserting the driver and guide surfaces for guiding the driver sideways.

11. The telescopic rail according to claim 1, wherein the first locking element is fixed to the middle rail or formed integrally therewith, and/or the second locking element is fixed to the inner rail or formed integrally therewith.

12. The telescopic rail according to claim 1, wherein the retaining trap is fixed to the end section of the middle rail facing in the insertion direction or to a section of the middle rail which lies between the end section of the middle rail pointing in the insertion direction and the end section of the inner rail pointing in the insertion direction when the inner rail is moved in the pull-out direction to the first pull-out end position on the middle rail.

13. The telescopic rail according to claim 1, wherein the retainer on the end section of the inner rail facing in the insertion direction is formed for locking the driver against the preload directed in the insertion direction by the power assist element at a distance from the insertion end position of the inner rail relative to the outer rail and for releasing the engagement with the driver during a displacement movement of the inner rail in the pull-out direction and for releasing the driver from the locking and for engaging with the driver during a displacement movement of the inner rail in the insertion direction.

14. The telescopic rail according to claim 7, wherein the at least one lead-in slope on the first retaining trap section is arranged for contact with an end section of a track of the inner rail.

15. The telescopic rail according to claim 8, wherein the power assist element on the self-closing mechanism comprises at least one coil spring.

16. The telescopic rail according to claim 9, wherein the damping element is an air pressure damper or oil pressure damper.
